(19) United States
(12) Patent Application Publication
(10) Pub. No.: US 2022/0019660 A1
(43) Pub. Date: Jan. 20, 2022

(54) INFORMATION PROCESSING APPARATUS, CONTROL METHOD, AND PROGRAM

(71) Applicant: NEC Corporation, Minato-ku, Tokyo (JP)

(72) Inventors: Etsuko ICHIHARA, Tokyo (JP); Yoshiaki SAKAE, Tokyo (JP); Kazuhiko ISOYAMA, Tokyo (JP); Jun NISHIOKA, Tokyo (JP)

(73) Assignee: NEC Corporation, Minato-ku, Tokyo (JP)

(21) Appl. No.: 17/294,167

(22) PCT Filed: Nov. 16, 2018
(86) PCT No.: PCT/JP2018/042464

§ 371 Date: May 14, 2021

(51) Int. Cl. G06F 21/55; G06F 16/901

(52) U.S. Cl. CPC G06F 21/55; G06F 2221/033; G06F 16/9024

(57) ABSTRACT

An information processing apparatus (2000) acquires an event graph (10) to be output and determines a subgraph satisfying a predetermined reference from the acquired event graph (10) to be output. In the event graph (10), an activity content in an event related to an activity of a program is represented as an edge (14), and each of a subject and an object of the event is represented as a node (12). The information processing apparatus (2000) outputs the event graph (10) with an output mode of the determined subgraph as a first mode and with an output mode of another portion as a mode other than the first mode. The first mode is a mode in which at least one of the number of nodes (12) and the number of edges (14) is reduced than the number included in the determined graph.

### TECHNICAL FIELD

The present invention relates to a technique of recognizing an activity of a program.

### BACKGROUND ART

In order to recognize the activity of a program running on a computer, a technique of expressing the activity of the program in a graph has been developed. The graph here means a data structure constituted by a set of nodes and a set of edges connecting the nodes.

Patent documents in the related art that disclose techniques for graphing program activities include, for example, Patent Document 1. To detect attacks on computing systems, Patent Document 1 discloses a technique of generating an event correlation graph in which a suspicious event is used as an edge, and also each of a subject and an object of the suspicious event is used as a node. More specifically, a suspiciousness score is defined based on attributes of the suspicious event, and detection of attack is performed by computing an attack score from the suspiciousness scores of the edges and nodes that constitute the event correlation graph. As one of the methods of computing the attack score, a method of computing based on the size of the event correlation graph is disclosed. Further, Patent Document 1 also discloses that the generated event correlation graph is presented to an administrator.

Further, there is Patent Document 2 as a related art document that discloses a technique related to displaying graphs. Patent Document 2 discloses a technique of segmenting and displaying a graph based on statements of each user in a social graph that connects and represents users. Further, Patent Document 2 also discloses a technique of computing a segment influence representing an influence of each segment on other users and displaying only a graph of a segment having a segment influence equal to or higher than a threshold value.

### RELATED DOCUMENTS

### Patent Documents

[Patent Document 1] PCT Japanese Translation Patent Publication No. 2016-528656

[Patent Document 2] Japanese Patent Application Publication No. 2015-164008

### SUMMARY OF THE INVENTION

### Technical Problem

On a system, various programs can carry out various activities. Therefore, when all the activities of the program are represented in a graph, the number of nodes or edges will increase, and a large number of computer resources will be consumed for outputting graphs.

Patent Document 1 discloses that when an attack score based on the size of an event correlation graph is computed, nodes or edges with low suspiciousness scores may be removed from the event correlation graph before computing the attack score. However, it is not disclosed to remove nodes or edges based on indices other than the suspiciousness score. Further, regarding the event correlation graph presented to the administrator, it is not disclosed to remove a part of nodes or edges in this way.

In Patent Document 2, a target of graphing is not the activity of the program. Therefore, even when the technique of Patent Document 2 is used, the computer resources required for outputting the graph representing the activities of the program cannot be reduced.

The present invention has been made in view of the above problems, one of the purposes is to provide a technique of reducing the number of computer resources required to output a graph representing an activity of a program.

### Solution to Problem

An information processing apparatus of the present invention includes: 1) a determination unit that acquires an event graph to be output and determines a subgraph satisfying a predetermined reference from the acquired event graph to be output; and 2) an output unit that outputs the event graph, with an output mode of the determined subgraph as a first mode and an output mode of another portion as a mode other than the first mode. The event graph represents an activity content in an event related to an activity of a program as an edge and represents each of a subject and an object of the event as a node. The first mode is a mode in which at least one of the number of nodes and the number of edges is reduced than the number of nodes and the number of edges included in the determined graph.

A control method of the present invention is executed by a computer. A control method includes: 1) a determination step of acquiring an event graph to be output and determining a subgraph satisfying a predetermined reference from the acquired event graph to be output; and 2) an output step of outputting the event graph, with an output mode of the determined subgraph as a first mode and an output mode of another portion as a mode other than the first mode. The event graph represents an activity content in an event related to an activity of a program as an edge and represents each of a subject and an object of the event as a node. The first mode is a mode in which at least one of the number of nodes and the number of edges is reduced than the number of nodes and the number of edges included in the determined graph.

A program of the present invention causes a computer to execute each step included in the control method of the present invention.

### Advantageous Effects of Invention

According to the present invention, there is provided a technique of reducing the number of computer resources required to output a graph representing an activity of a program.

### BRIEF DESCRIPTION OF THE DRAWINGS

The above-described object, other objects, features, and advantages will be further clarified by the preferred embodiments described below and the accompanying drawings.

FIG. 1 is a diagram illustrating an outline of an operation of an information processing apparatus according to Example Embodiment 1.

FIG. 2 is a diagram illustrating a configuration of the information processing apparatus according to Example Embodiment 1.

FIG. 3 is a diagram illustrating a computer for implementing the information processing apparatus.

FIG. 4 is a flowchart illustrating a flow of a process executed by the information processing apparatus of Example Embodiment 1.

FIG. 5 is a diagram illustrating event information in a table format.

FIG. 6 is a diagram illustrating a method of generating one event graph by connecting graphs generated by different target apparatuses.

FIG. 7 is a diagram illustrating an event graph in which an apparatus of a communication partner is represented as a node.

FIG. 8 is a diagram illustrating an event graph including a subgraph that satisfies a predetermined reference of Example 1.

FIG. 9 is a diagram illustrating an event graph including a subgraph that satisfies a predetermined reference of Example 2.

FIG. 10 is a diagram illustrating an event graph including a subgraph that satisfies a predetermined reference of Example 3.

FIG. 11 is a diagram illustrating an event graph including a subgraph representing that one process accesses a plurality of files existing under a predetermined directory.

FIG. 12 is a diagram illustrating an event graph including a subgraph representing that one process accesses a plurality of files shown in a predetermined list.

### DESCRIPTION OF EMBODIMENTS

Hereinafter, embodiments of the present invention will be described with reference to the drawings. In all the drawings, the same constituents will be referred to with the same numerals, and the description thereof will not be repeated. Further, in each block diagram, each block represents a functional unit configuration, not a hardware unit configuration, unless otherwise specified.

### Example Embodiment 1

<Overview>

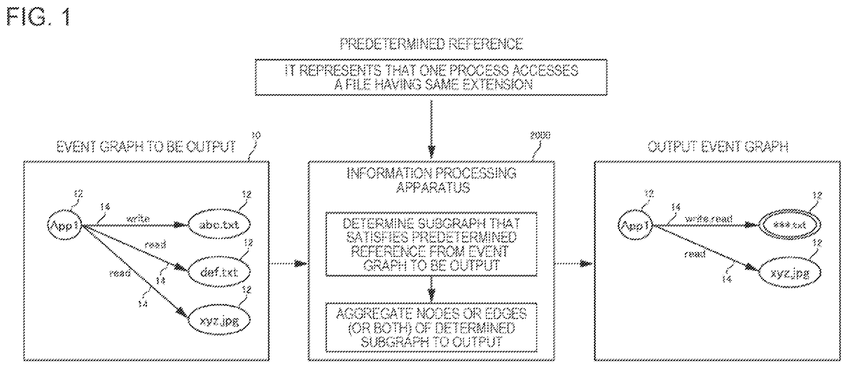

FIG. 1 is a diagram illustrating an outline of an operation of an information processing apparatus 2000 according to Example Embodiment 1. FIG. 1 is a diagram representing the conceptual description to facilitate understanding of the operation of the information processing apparatus 2000 and are not intended to specifically limit the operation of the information processing apparatus 2000.

The information processing apparatus 2000 acquires and outputs an event graph 10 to be output. The event graph 10 is a data structure constituted by a set of nodes 12 and a set of edges 14 connecting the nodes 12. In the event graph 10, one event is represented by the edge 14, and the two nodes 12 that are connected by the edge 14.

An event represents an activity that a process (running program) performs on some object. The edge 14 represents an activity content of the process in the event. The two nodes 12 that are connected by the edge 14 represent a subject and an object of the event, respectively. The subject of the event is a process. The object of the event is a process, a file, or the like. For example, an event that a certain process generates may be the activation of another process, communication with another process, access to a file, or the like.

In FIG. 1, a flow of the event is represented by outputting an arrow representing a direction as the edge 14. Specifically, the node 12 connected to the start point of the edge 14 represents the subject of the event, and the node 12 connected to the end point of the edge 14 represents the object of the event. By viewing the nodes 12 in order in the direction represented by the edge 14, the time-series of the events can be recognized. Hereinafter, a sequence of one or more events arranged in time-series is referred to as an event sequence.

Note that, an output mode of the edge 14 is not necessarily limited to representing the direction, and may not necessarily represent the direction such as a straight line. When the edge 14 is output in a mode that does not represent the direction, for example, a rule such as “in the event graph 10, the flow of events is represented in the direction from left to right” may be defined, and the event graph 10 may be generated according to the rule.

The event graph 10 is used, for example, by a user who monitors the target apparatus. The user recognizes a situation of the target apparatus by viewing the event graph 10. For example, the user views the event graph 10 to check whether or not an event representing an abnormal state occurs in the target apparatus. The event representing an abnormal state is, for example, an event that is considered to be mediated by malware. However, the “abnormality” referred to here is not limited to a security abnormality. For example, an abnormality such as a process performing unexpected operations due to a program bug is also included.

For a user who views the event graph 10, the importance of each element constituting the output event graph 10 may differ depending on the purpose or the like of the viewing. For example, for a user who wants to recognize whether the target apparatus has an abnormality, it is considered that a portion representing an event sequence occurring due to the abnormal activity is more important than a portion representing an event sequence occurring due to the general activity.

Therefore, the information processing apparatus 2000 determines the mode of the subgraphs constituting the event graph 10 based on a predetermined reference. Specifically, the information processing apparatus 2000 determines a subgraph satisfying a predetermined reference (hereinafter, a determined subgraph) from among one or more subgraphs constituting the event graph 10. The information processing apparatus 2000 outputs the event graph 10 by outputting the determined subgraph in a first mode and outputting another portion in a mode other than the first mode. The first mode is a mode in which at least one of the number of nodes and the number of edges is reduced than the number of nodes and the number of edges included in the determined subgraph. Hereinafter, the output according to the first mode is also expressed as “aggregated output”.

For example, in FIG. 1, the event graph 10 to be output represents that a process of an application named App1 accesses two text files and one image file. As a predetermined reference, “it represents that one process accesses a plurality of files having the same extension” is defined.

Therefore, the information processing apparatus 2000 determines a subgraph representing that two text files (files having the same extension of txt) are accessed from App1 as a subgraph satisfying the predetermined reference. The information processing apparatus 2000 aggregates and outputs the subgraph. Specifically, the information processing apparatus 2000 converts the nodes 12 representing each of the two accessed text files into one node 12 representing any text file named “***.txt” and outputs the node 12.

<Advantageous Effect>

In this way, according to the aggregated output of the subgraphs satisfying the predetermined reference, even when the event graph 10 to be output includes many nodes 12 or edges 14, the event graph 10 becomes easier for a user to view because a part of the event graph 10 is properly aggregated. Therefore, the information processing apparatus 2000 achieves an effect that the convenience of the event graph 10 is improved for the user.

In particular, when the predetermined reference is defined such that the subgraph representing the event sequence that occurs in a normal state (general state) satisfies the predetermined reference, the information about the normal state can be reduced from the event graph 10. As a result, since the attention of a user is easily directed to the event sequence that occurs in the abnormal state, it is possible to prevent the user from overlooking the event sequence that occurs in the abnormal state. Therefore, the safety of the target apparatus can be improved.

Further, by aggregately outputting the subgraphs satisfying the predetermined reference, it is possible to improve the convenience of the event graph 10 for the user as described above and reduce the computer resources required to output the event graph 10. For example, since the number of nodes 12 or edges 14 included in the event graph 10 is reduced, the screen data representing the event graph 10 becomes simpler. Therefore, it is possible to implement to reduce the processor resources required for generating the screen data representing the event graph 10, reduce the display area of the display device required for displaying the screen data, or the like. Further, since the number of nodes 12 or edges 14 included in the event graph 10 is reduced, the data size of the information representing the event graph 10 is reduced. Therefore, the storage area required for storing the information representing the event graph 10 can be reduced. Further, when the information processing apparatus 2000 transmits information representing the event graph 10 to the other apparatus, the network bandwidth required for the transmission can be reduced.

Hereinafter, the information processing apparatus 2000 of the present example embodiment will be described in more detail.

<Example of Functional Configuration of Information Processing Apparatus 2000>

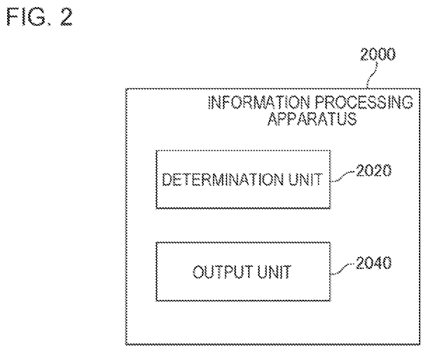

FIG. 2 is a diagram illustrating a configuration of the information processing apparatus 2000 according to Example Embodiment 1. The information processing apparatus 2000 includes a determination unit 2020 and an output unit 2040. The determination unit 2020 determines a subgraph satisfying the predetermined reference from the event graph 10 to be output. The output unit 2040 outputs the event graph 10. Of the event graph 10, a subgraph satisfying the predetermined reference is output in the first mode, and the other portion is output in a mode other than the first mode.

<Hardware Configuration of Information Processing Apparatus 2000>

Each functional configuration unit of the information processing apparatus 2000 may be implemented by hardware (for example, a hard-wired electronic circuit or the like) that implements each functional configuration unit, or may be implemented by a combination of hardware and software (for example, a combination of an electronic circuit and a program for controlling the electronic circuit). Hereinafter, a case where each functional configuration unit of the information processing apparatus 2000 is implemented by a combination of hardware and software will be further described.

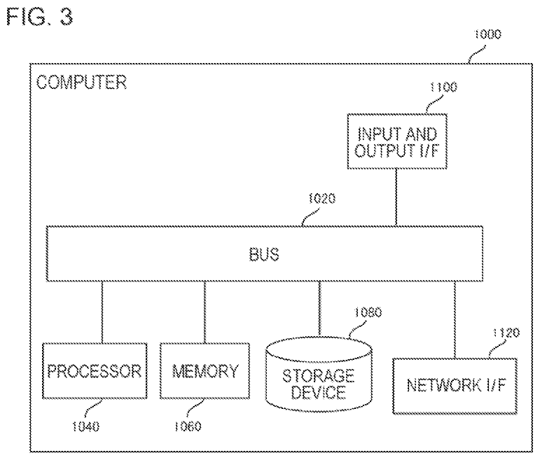

FIG. 3 is a diagram illustrating a computer 1000 for implementing the information processing apparatus 2000. The computer 1000 is any computer. For example, the computer 1000 is a Personal Computer (PC), a server machine, a tablet terminal, a smartphone, or the like. The computer 1000 may be a dedicated computer designed to implement the information processing apparatus 2000 or may be a general-purpose computer.

The computer 1000 includes a bus 1020, a processor 1040, a memory 1060, a storage device 1080, an input and output interface 1100, and a network interface 1120. The bus 1020 is a data transmission path for the processor 1040, the memory 1060, the storage device 1080, the input and output interface 1100, and the network interface 1120 to mutually transmit and receive data. However, the method of connecting the processors 1040 and the like to each other is not limited to the bus connection. The processor 1040 is a processor such as a Central Processing Unit (CPU), a Graphics Processing Unit (GPU), or a Field-Programmable Gate Array (FPGA). The memory 1060 is a main storage device implemented by using a Random Access Memory (RAM) or the like. The storage device 1080 is an auxiliary storage device implemented by using a hard disk drive, a Solid State Drive (SSD), a memory card, a Read Only Memory (ROM), or the like. However, the storage device 1080 may be configured with the same hardware as the hardware configuring the main storage device, such as RAM.

The input and output interface 1100 is an interface for connecting the computer 1000 and the input and output devices. The network interface 1120 is an interface for connecting the computer 1000 to a communication network. The communication network is, for example, a Local Area Network (LAN) or a Wide Area Network (WAN). A method of connecting the network interface 1120 to the communication network may be a wireless connection or a wired connection.

The storage device 1080 stores a program module that implements functional configuration units of the information processing apparatus 2000. The processor 1040 implements the function corresponding to each program module by reading each of these program modules into the memory 1060 and executing the modules.

<About Target Apparatus>

The target apparatus is any computer such as a PC, a server machine, a tablet terminal, or a smartphone. Further, the target apparatus is not limited to a physical machine and may be a virtual machine.

The number of target apparatuses may be one or a plurality. For example, the information processing apparatus 2000 generates an event graph 10 for each of a plurality of target apparatuses. However, as will be described later, when the plurality of target apparatuses communicate with each other, one event graph 10 may be generated for the plurality of target apparatuses by connecting the event graphs 10 generated for each target apparatus. The one event graph 10 generated for the plurality of target apparatuses in this way can also be viewed as an event graph 10 generated for a computer system (hereinafter, a target system) constituted by the plurality of target apparatuses.

<Process Flow>

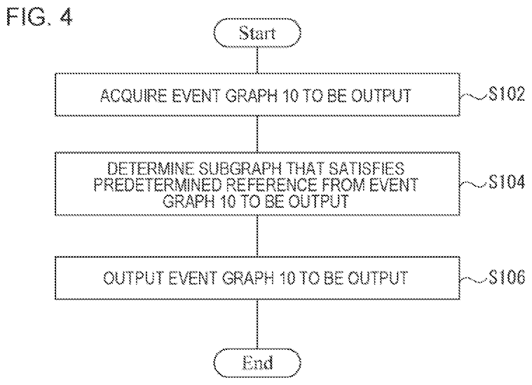

FIG. 4 is a flowchart illustrating a flow of a process executed by the information processing apparatus 2000 of Example Embodiment 1. The determination unit 2020 acquires the event graph 10 to be output (S102). The determination unit 2020 determines a subgraph satisfying the predetermined reference from the event graph 10 to be output (S104). The output unit 2040 outputs the event graph 10 to be output (S106). At this time, the determined subgraph is output in the first mode, and the other portion is output in a mode other than the first mode.

<About Event>

As mentioned above, the event is an activity that a process performs on some object. When a certain process acts as an object of another process, these processes may be operated on the same OS (Operating System) with each other or may be operated on different OS from each other. As an example of the latter, for example, it is conceivable that a certain process communicates with another process that is operated on another OS by using a socket interface.

For example, the event is identified by information representing four elements: subject, object, activity content, and occurrence time. Therefore, for example, the event information indicates a combination of subject information representing a subject, object information representing an object, content information representing the content of an activity, and occurrence time.

The subject information is, for example, information for identifying the process that generated the event. Hereinafter, the information for identifying the process is referred to as process identification information. The process identification information indicates, for example, a name of the process. In addition, for example, the process identification information indicates a process ID (Identifier), a name or a path of an execution file of a program corresponding to the process, a hash value or a digital signature of the execution file, a name of an application implemented by the execution file, or the like. Note that, the process identification information may indicate a combination of a plurality of identifiers such as a combination of an execution file path and a process ID.

The object information is, for example, the type and identification information of the object. The type of object includes, for example, a process, a file, a socket, or the like. When the object is a process, the object information includes process identification information about the process.

When the object is a file, the object information includes information for identifying the file (hereinafter, file identification information). The file identification information indicates, for example, a name or a path of the file. Further, when the object is a file, the object information may indicate a hash value of the file, a combination of the identification information of a file system and the identification information (Mode number or OBJECT ID) of the disk blocks constituting the file on the file system, or the like.

When the object is a socket, for example, the object information includes an identifier assigned to the socket.

The information representing the activity content (hereinafter, it is referred to as content information) is, for example, an identifier assigned in advance to various activity contents. For example, different identifiers are assigned to the contents of different activities such as “activate a process”, “stop a process”, “open a file”, “read data from a file”, “write data to a file”, “open a socket”, “read data from a socket”, or “write data to a socket”. Note that, access to a socket means access to another apparatus associated with the socket.

In order to generate the event graph 10, information representing each event generated in the target apparatus is required. Hereinafter, this information is referred to as event information. For example, the event information indicates a combination of the subject information, object information, content information, and occurrence time for each event generated in the target apparatus.

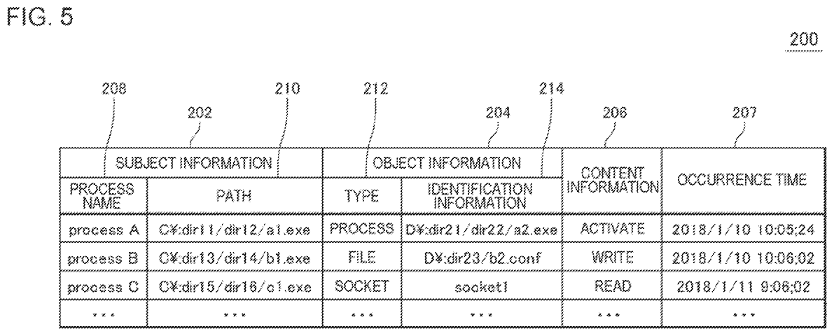

FIG. 5 is a diagram illustrating the event information in a table format. Hereinafter, the table in FIG. 5 is referred to as a table 200. The table 200 includes subject information 202, object information 204, content information 206, and occurrence time 207. The subject information 202 includes a name 208 and a path 210 of the process. The object information 204 includes a type 212 and identification information 214. The occurrence time 207 indicates the time when the event has occurred.

For example, the event information can be generated by recording information about each event generated by the target apparatus in a log. The existing technique can be used as a technique of recording information about the events that have occurred in a log.

<About Generation of Event Graph 10>

The event graph 10 is generated based on the event information described above. The generation of the event graph 10 may be performed by the information processing apparatus 2000 or may be performed by an apparatus other than the information processing apparatus 2000. In the following, for the sake of clarity, it is assumed that the event graph 10 is generated by the information processing apparatus 2000.

The edge 14 and the node 12 in the event graph 10 are defined by the event information. Specifically, the content information defines the edge 14, and the subject information and the object information define each of two nodes 12 that are connected by the edge 14. Here, the existing technique can be used as a technique of generating a graph by using information that defines an edge and nodes at both ends thereof.

Basically, when the object in a certain event and the subject in another event match, the former and the latter are represented with the same node 12, and thereby the event graph 10 in which information about a plurality of events is concatenated is generated.

However, it is preferable that the event graph 10 is generated in consideration of the occurrence time. For example, when the object of a certain event becomes the subject of another event, the occurrence time of the former event becomes earlier than the occurrence time of the latter event. Therefore, the information processing apparatus 2000 is made to be generated in consideration of the order of occurrence time between events in this way.

Further, even when the object of a certain event and the subject of another event are the same, the former event and the latter event may not be said to be a series of events to be connected. Specifically, when the occurrence time of the former event and the occurrence time of the latter event are significantly different, it is considered that these events are not a series of events but events that occur independently, and it is not preferable to connect these events.

Therefore, for example, a threshold value of the occurrence time is defined for the events to be connected. Thereafter, when the object indicated by certain event information and the subject of the event indicated by other event information match, the information processing apparatus 2000 determines whether or not a difference between the occurrence time indicated by the latter event information and the occurrence time indicated by the former event information is equal to or less than the above threshold value.

When the difference is equal to or less than the above threshold value, the information processing apparatus 2000 connects these events by making the node 12 indicating the object of the former event and the node 12 indicating the subject of the latter event the same node 12. On the other hand, when the difference is larger than the above threshold value, the information processing apparatus 2000 does not connect these events by making the node 12 representing the object of the former event and the node 12 representing the subject of the latter event different nodes 12.

Note that, it is not necessary that all the generated event graphs 10 be output targets. For example, the event graph 10 may be generated periodically, and the event graph 10 may be output only when an input operation is performed by a user. In this case, the event graph 10 that is periodically generated is used, for example, to generate the score information described above. The method of generating the score information will be described later.

<<About Case Where Plurality of Target Apparatuses are Present>>

When a plurality of target apparatuses are present, for example, the information processing apparatus 2000 generates an event graph 10 for each target apparatus. However, as described above, regarding the plurality of target apparatuses communicating with each other, it is preferable to connect the event graphs 10 for these target apparatuses.

The event graph 10 generated for each of the plurality of target apparatuses is connected through, for example, the node 12 representing an event related to communication between the target apparatuses. The communication between the target apparatuses is performed by using, for example, a socket interface. For example, data transmission from the target apparatus to another target apparatus is implemented by a writing operation or the like with respect to the socket. On the other hand, the reception of data transmitted from another target apparatus is implemented by a reading operation or the like for the socket.

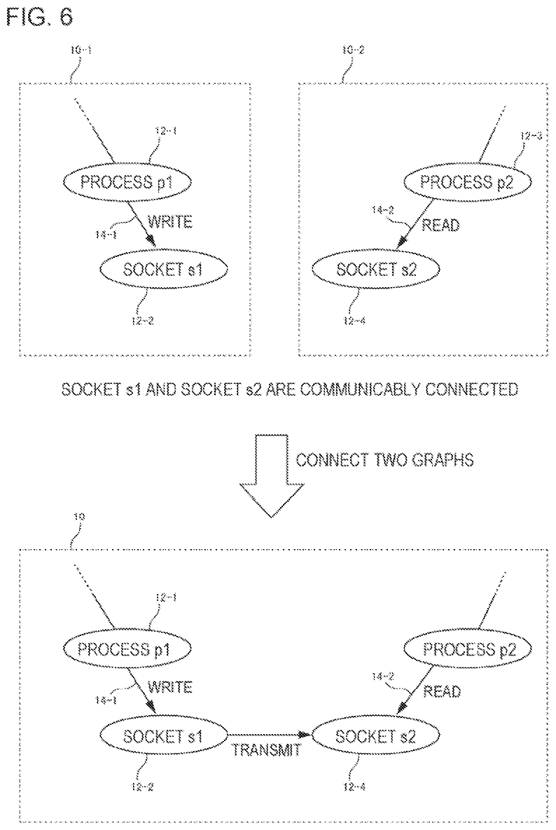

The information processing apparatus 2000 connects the event graphs 10 generated for the different target apparatuses by, for example, matching events that use sockets performed in different target apparatuses as objects. FIG. 6 is a diagram illustrating a method of generating one event graph 10 by connecting graphs generated by different target apparatuses.

In the upper part in FIG. 6, an event graph 10-1 and an event graph 10-2 each generated for different target apparatuses are not connected to each other. In the event graph 10-1, the process p1 represented by a node 12-1 performs data writing with respect to a socket s1 represented by a node 12-2. In the event graph 10-2, the process p2 represented by a node 12-3 performs data reading with respect to a socket s2 represented by a node 12-4.

Here, it is assumed that the socket s1 and the socket s2 are communicably connected (a connection is established between the sockets). In this way, the process p1 transmits data to the process p2 through the sockets s1 and s2.

The information processing apparatus 2000 connects the event graph 10-1 and the event graph 10-2 by connecting the sockets s1 and s2 described above and generates one event graph 10 (see the lower part in FIG. 6).

Note that, it is possible to determine which socket and which socket are communicably connected by, for example, matching the information related to the network (port number and IP address of the communication partner) that each socket has.

<<Case Where Apparatus of Communication Partner is Represented as Node>>

When the target apparatus communicates with another apparatus, the apparatus of the communication partner may be represented as a single node. The apparatus of the communication partner may be another target apparatus or may be an apparatus other than the target apparatus. For example, when the target apparatus is an apparatus that functions as a server, the client that uses the server is an apparatus of the communication partner. Further, when the target apparatus is an apparatus that functions as a client, the server accessed by the target apparatus becomes an apparatus of the communication partner.

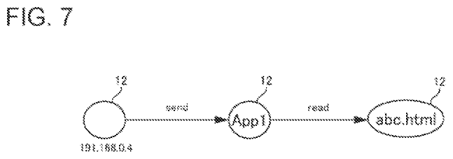

FIG. 7 is a diagram illustrating the event graph 10 in which an apparatus of a communication partner is represented as a node. FIG. 7 represents that data is transmitted from an apparatus having an IP address of 191.168.0.4 to an application App1 of the target apparatus, and the App1 reads an abc.html after receiving the data.

As shown in FIG. 7, there is a case where the activity of the process on the target apparatus is started by receiving the access from the apparatus of the communication partner. In this case, the actual activity of the process is an operation of “a process reads data received from an apparatus of a communication partner from a socket”. That is, it is an event in which the process is a subject, the socket that manages the data received from the apparatus of the communication partner is an object, and read is an activity content. However, as shown in FIG. 7, it is considered more natural and easier to understand as a graph when it is represented as an event of data transmission from the apparatus of the communication partner to the process.

Therefore, regarding the event of “a process reads data received from another apparatus from a socket”, the node 12 and the edge 14 may be generated so as to be represented as an event of “data transmission from an apparatus which is a data transmission source to a process”.

Note that, the identification information of the apparatus of the communication partner is not limited to the IP address described above, and may be another type of network address (for example, MAC address), domain name, UUID (Universally Unique Identifier), or the like.

<Acquisition of Event Graph 10 to be Output>

The determination unit 2020 acquires the event graph 10 to be output. For example, the determination unit 2020 acquires the event graph 10 that is periodically generated and handles the acquired event graph 10 as an event graph 10 to be output.

In addition, for example, the event graph 10 to be output is acquired in response to an input operation by a user. For example, the user operation is an operation for specifying an OBJECT (a process, a file, or the like) that is the subject or an object in the target apparatus. For example, the information processing apparatus 2000 acquires the event information in response to the input operation and generates the event graph 10 that includes the specified OBJECT by using the acquired event information. The “event graph 10 that includes the specified OBJECT” is, for example, a graph in which the node 12 representing the specified OBJECT is a start point node or an end point node. The information processing apparatus 2000 handles the generated event graph 10 as the event graph 10 to be output. The predetermined period may be defined in advance or may be specified by an input operation by a user.

Another example of an input operation by a user is an input operation that specifies a period. In this case, the information processing apparatus 2000 acquires the event information indicating an event that occurs in the target apparatus during the specified period and generates an event graph 10 by using the acquired event information. When the event graph 10 is generated for the event that occurs during a certain specified period, there is a possibility that a plurality of event graphs 10 that are not connected to each other are generated. In this case, the information processing apparatus 2000 may handle each of the generated event graphs 10 as an event graph 10 to be output or may handle a part of the event graph 10 (for example, an event graph 10 selected by a user) as an event graph 10 to be output.

<Regarding Predetermined Reference>

The determination unit 2020 determines a subgraph that satisfies a predetermined reference from the subgraphs included in the event graph 10. For this reason, the determination unit 2020 acquires reference information representing a predetermined reference. The reference information may be set by the determination unit 2020 in advance or may be stored in a storage device accessible from the determination unit 2020.

The predetermined reference is preferably a reference satisfied by a subgraph representing an event sequence that occurs in the target apparatus in the normal state (general state). By doing so, it is possible to aggregate the subgraphs representing the event sequences that occur in the normal state and make it easier for the user to pay attention to the event sequence that occurs in the abnormal state.

Various predetermined references can be adopted. Hereinafter, some specific examples of the predetermined reference will be illustrated.

### EXAMPLE 1

For example, a predetermined reference of “it represents that a plurality of processes representing the same type of application access the same object” can be adopted. In other words, it is a predetermined reference indicating that “a plurality of nodes 12 representing the same type of application are connected to the same node 12”. Regarding the types of applications, there are various types such as browsers, document creation software, or mailers.

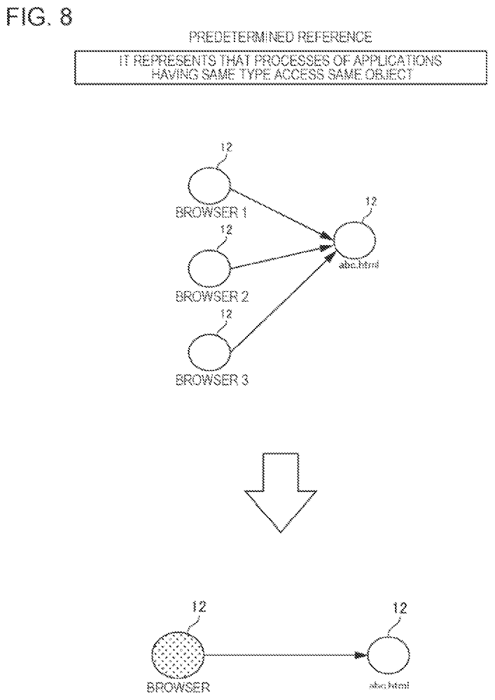

FIG. 8 is a diagram illustrating an event graph 10 including subgraphs that satisfy a predetermined reference of Example 1. The event graph 10 at the upper part in FIG. 8 includes subgraphs representing that the three processes of the three types of browsers, which are browser 1 to browser 3, access one HTML file named abc.html. The subgraphs satisfy the predetermined reference of Example 1 described above.

Therefore, for example, the output unit 2040 aggregates the nodes 12 representing these three browsers into one representative node and outputs the node. The graph at the lower part in FIG. 8 illustrates the event graph 10 in which the aggregation of the determined subgraphs is performed.

Note that, as described above, the types of applications to be aggregated and displayed may be all types or may be determined types. In the latter case, for example, information indicating the type of application to be aggregated and displayed is stored in th storage device accessible from the output unit 2040. The output unit 2040 performs the above-mentioned aggregation and display only for the types of applications indicated in the information.

### EXAMPLE 2

For example, a predetermined reference of “it represents that one process accesses a plurality of files having the same extension” can be adopted. In other words, it is a predetermined reference indicating that “one node 12 is connected to a plurality of nodes 12 representing files having the same extension”.

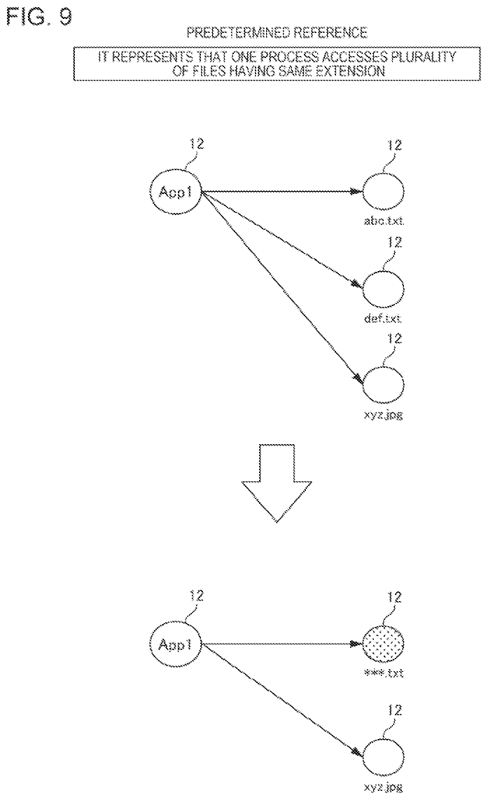

FIG. 9 is a diagram illustrating the event graph 10 including subgraphs that satisfy a predetermined reference of Example 2. The event graph 10 at the upper part in FIG. 9 includes subgraphs representing that the process of the application named App1 accesses two text files. The subgraphs satisfy the predetermined reference of Example 2 described above.

Therefore, for example, the output unit 2040 aggregates the nodes 12 representing these two text files into one representative node and outputs the node. The graph at the lower part in FIG. 9 illustrates the event graph 10 in which the aggregation of the determined subgraphs is performed.

### EXAMPLE 3

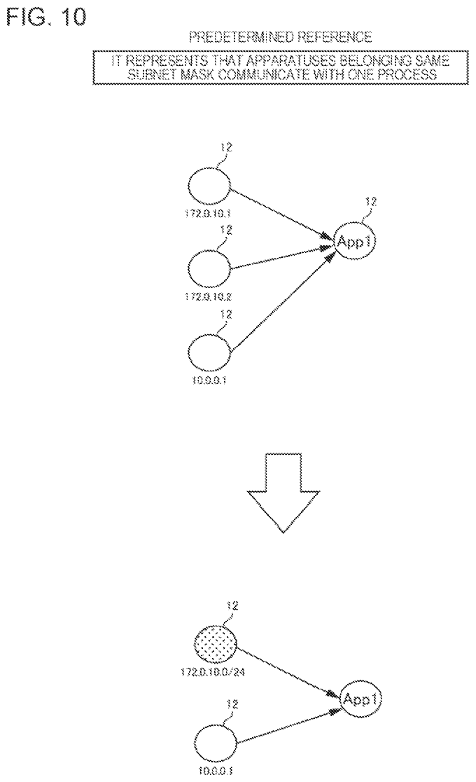

For example, a predetermined reference of “it represents communication with one process performed by a plurality of apparatuses belonging to the same subnet” can be adopted. FIG. 10 is a diagram illustrating the event graph 10 including subgraphs that satisfy a predetermined reference of Example 3. The event graph 10 at the upper part in FIG. 10 includes subgraphs representing that two apparatuses belonging to the subnet 172.0.10.0/24 communicate with the process of the application named App1.

Therefore, for example, the output unit 2040 aggregates the nodes 12 representing these two apparatuses into one representative node and outputs the node. The graph at the lower part in FIG. 10 illustrates the event graph 10 in which the aggregation of the determined subgraphs is performed.

### EXAMPLE 4

For example, a predetermined reference of “it represents that one process accesses a plurality of files or directories satisfying a second predetermined reference” can be adopted. For example, as the second predetermined reference, a reference of “it exists under a predetermined directory” is defined. As a predetermined directory, for example, one or more directories known to be accessed at the time of an attack are defined.

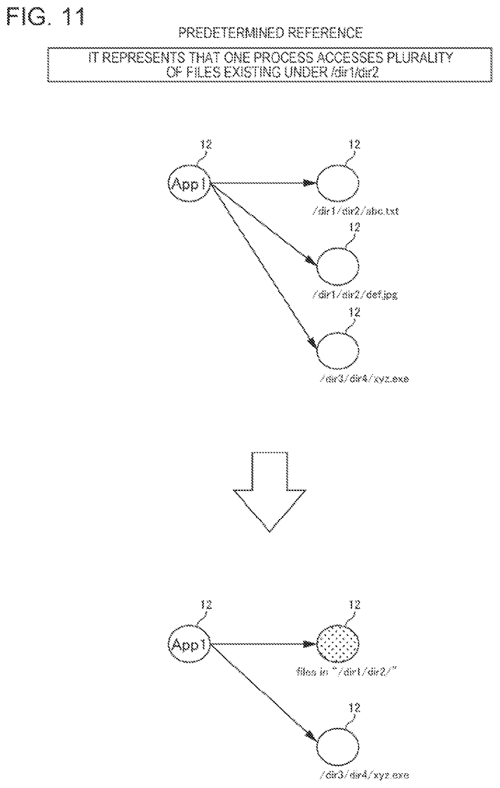

FIG. 11 is a diagram illustrating the event graph 10 including subgraphs representing that one process accesses a plurality of files existing under a predetermined directory. In this example, the predetermined reference indicates “it represents that one process accesses a plurality of files or directories existing under /dir1/dir2”. The second predetermined reference indicates “it exists under the directory /dir1/dir2”. The event graph 10 in FIG. 11 includes subgraphs representing that the process of the application named App1 accesses two files existing under “/dir1/dir2”.

The event graph 10 at the upper part in FIG. 11 includes subgraphs representing that the process of the application named App1 accesses two files existing under /dir1/dir2. Therefore, for example, the output unit 2040 aggregates the nodes 12 representing these two files into one representative node and outputs the node. The graph at the lower part in FIG. 11 illustrates the event graph 10 in which the aggregation of the determined subgraphs is performed.

The “predetermined directory” is defined for each application that becomes a subject, for example. For known applications, it is possible to recognize in advance which directory the files to be accessed are under. Therefore, for example, by defining a directory that is known to be accessed by an application as a predetermined directory corresponding to that application, it is possible to aggregate the subgraphs representing an access to files that can be accessed without problems. That is, the subgraphs representing activities of the normal processes can be aggregated.

Note that, the “predetermined directory” does not have to be defined for each application that becomes a subject, and may be defined in common for all applications.

As another example of the second predetermined reference, a reference of “it represents that one process accesses a plurality of files shown in a predetermined list” is defined. For example, in association with an application that becomes a subject, a list of files (for example, a library file or the like that the application reads at the execution time) that are known to be accessed by the application is defined. By doing this, it is possible to aggregate subgraphs representing an access to files that can be accessed by the application without any problems. That is, the subgraphs representing activities of the normal processes can be aggregated.

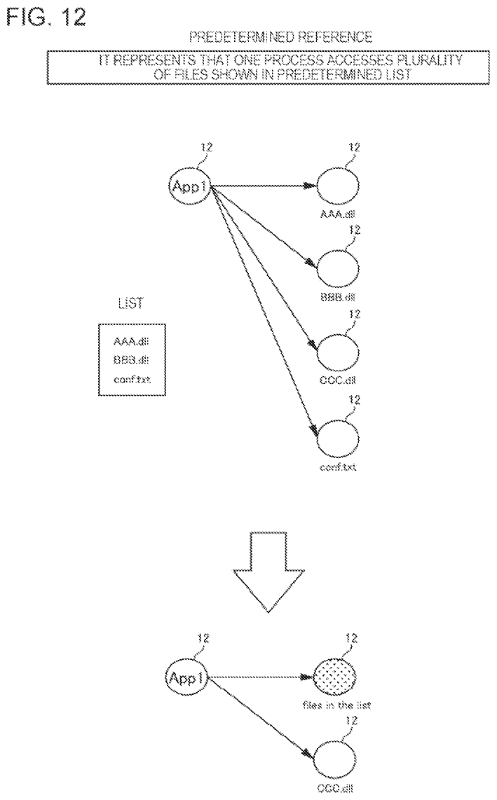

FIG. 12 is a diagram illustrating the event graph 10 including subgraphs representing that one process accesses a plurality of files shown in a predetermined list. The event graph 10 at the upper part in FIG. 12 includes subgraphs representing that the process of the application named App1 accesses three files shown in the list. Therefore, for example, the output unit 2040 aggregates the nodes 12 representing these three files into one representative node and outputs the node. The graph at the lower part in FIG. 12 illustrates the event graph 10 in which the aggregation of the determined subgraphs is performed.

The second predetermined reference may be defined in a negative form. For example, it is a reference indicating that “it does not exist under a predetermined directory” or “it is not a file included in a predetermined list”.

For example, it is conceivable that a case where an access to files existing under directory D, which is well known as an attack target, may not be aggregated, and an access to other files may be aggregated. In such a case, by defining the second reference indicating that “it does not exist under a directory D”, an access to files that do not exist under the directory D can be aggregated and output, and an access to files that exist under the directory D can be output without being aggregated. In this way, it is possible to output a graph that makes it easy to pay attention to the activities of processes that may be an attack.

<Output of Event Graph 10: S106>

The output unit 2040 outputs the event graph 10 to be output (S106). At this time, the determined subgraphs (the subgraphs satisfying the predetermined reference) are aggregated and output. The output mode for the portion other than the determined subgraph is any mode other than the first mode and is a mode that all the nodes 12 and the edges 14 are output without being aggregated, for example.

In the subgraph that satisfies the above-mentioned predetermined reference, the nodes 12 are connected via 1 to N or N to 1 (N>1) relation. Therefore, for the subgraphs having such a 1 to N or N to 1 configuration, the output unit 2040 aggregates N nodes 12 into one representative node and outputs the node.

Here, it is preferable that the form (shape, color, pattern, or the like) of the representative node is different from the form of the general node 12. By doing so, a user can intuitively recognize that the alternative node is an aggregation of a plurality of nodes 12 or edges 14. For example, in the example in FIG. 1, the general node 12 has one frame, whereas the representative node has a double frame. Further, in the examples in FIGS. 9 to 12, the general node 12 is not provided with a pattern, whereas the representative node is provided with a dot pattern.

Note that, the method of reducing the nodes 12 or the edges 14 in the aggregated output is not limited to the methods, illustrated so far, of representing the determined subgraphs by one representative node and one edge. For example, only the edges between the nodes 12 included in the determined subgraph may be omitted.

Further, as illustrated so far, it is preferable to add character information indicating the contents to the node 12 or the edge 14. For example, an application name or a file name is added to the node 12. Further, character information representing the activity content such as read or write is added to the edge 14.

Any kind of character information is attached when the aggregated output is performed. For example, the output unit 2040 adds character information listing all the aggregated file names or activity contents to the event graph 10. In addition, for example, the format of the character information to be added may be defined according to the predetermined reference used for aggregation. For example, when a plurality of files having the same extension are aggregated, character information including the extension is added (see FIG. 9). In this way, when the character information to be added to the event graph 10 after aggregation is defined according to the predetermined reference, the format of the character information is included in the reference information.

Various output destinations can be adopted as the output destination of the event graph 10 to be output. For example, the output unit 2040 outputs the event graph 10 to a display device connected to the information processing apparatus 2000. By doing so, the event graph 10 is displayed on the display device. Note that, any existing technique can be used as the technique for displaying the graph on the display device. In addition, for example, the output unit 2040 may output (transmit) the event graph 10 to an apparatus other than the information processing apparatus 2000. In addition, for example, the output unit 2040 may output (may store) the event graph 10 to a storage device.

In a case where the event graph 10 is displayed on the display device, when aggregated output is performed for the determined subgraph, it is possible to reduce the size of the entire event graph 10 as compared with the case where the aggregated output is not performed. That is, when the event graph 10 is represented as an image, the image size can be reduced. Therefore, it is possible to reduce the processor resources used for the process that generates an image representing the event graph 10, reduce the storage area used for storing the generated image, and reduce the screen area of the display device used for displaying the generated image. Further, when the image size of the event graph 10 is reduced, the event graph 10 can be displayed on the display device even when the resolution of the display device is relatively low. That is, the resolution of the display device required to display the event graph 10 can be suppressed to a low level.

<Change of Output Mode of Determined Subgraph>

After the event graph 10 to be output is output, the information processing apparatus 2000 may receive a user operation for changing the output mode of the determined subgraph. For example, when a determined subgraph is aggregated and output to the representative node, the output mode of the determined subgraph is changed from the first mode to the second mode in response to the user performing a predetermined operation (for example, double click) on a representative node. That is, the determined subgraphs are displayed without being aggregated. By doing so, the content can be recognized in detail when the user wants to recognize the content in detail while outputting the determined subgraph in an inconspicuous mode.

Although the example embodiments of the present invention have been described above with reference to the drawings, these are examples of the present invention, and a configuration in which the above example embodiments are combined or various configurations other than the above can be adopted.

The whole or part of the example embodiments disclosed above can be described as, but not limited to, the following supplementary notes.

1. An information processing apparatus including: a determination unit that acquires an event graph to be output and determines a subgraph satisfying a predetermined reference from the acquired event graph to be output; and an output unit that outputs the event graph, with an output mode of the determined subgraph as a first mode and an output mode of another portion as a mode other than the first mode, in which the event graph represents an activity content in an event related to an activity of a program as an edge and represents each of a subject and an object of the event as a node, and the first mode is a mode in which at least one of the number of nodes and the number of edges is reduced than the number of nodes and the number of edges included in the determined graph.

2. The information processing apparatus according to 1., in which the predetermined reference is a reference satisfied by a subgraph representing an event sequence that occurs in a normal state.

3. The information processing apparatus according to 2., in which the predetermined reference is a reference indicating that one process accesses a plurality of files having the same extension.

4. The information processing apparatus according to 2., in which the predetermined reference is a reference indicating that it represents communication with one process performed by a plurality of apparatuses belonging to the same subnet.

5. The information processing apparatus according to 2., in which the predetermined reference is a reference indicating that one process accesses a plurality of files or directories satisfying a second predetermined reference.

6. The information processing apparatus according to 5., in which the second predetermined reference is a reference indicating that a file or a directory exists under a predetermined directory, or a reference indicating that a file or a directory is shown in a predetermined list.

7. The information processing apparatus according to any one of 1. to 6., in which the determination unit acquires an event graph representing an event sequence that includes the node representing the subject or the object of the event that is specified by an input operation.

8. A control method executed by a computer, the method including: a determination step of acquiring an event graph to be output and determining a subgraph satisfying a predetermined reference from the acquired event graph to be output; and an output step of outputting the event graph, with an output mode of the determined subgraph as a first mode and an output mode of another portion as a mode other than the first mode, in which the event graph represents an activity content in an event related to an activity of a program as an edge and represents each of a subject and an object of the event as a node, and the first mode is a mode in which at least one of the number of nodes and the number of edges is reduced than the number of nodes and the number of edges included in the determined graph.

9. The control method according to 8., in which the predetermined reference is a reference satisfied by a subgraph representing an event sequence that occurs in a normal state.

10. The control method according to 9., in which the predetermined reference is a reference indicating that one process accesses a plurality of files having the same extension.

11. The control method according to 9., in which the predetermined reference is a reference indicating that it represents communication with one process performed by a plurality of apparatuses belonging to the same subnet.

12. The control method according to 9., in which the predetermined reference is a reference indicating that one process accesses a plurality of files or directories satisfying a second predetermined reference.

13. The control method according to 12., in which the second predetermined reference is a reference indicating that a file or a directory exists under a predetermined directory, or a reference indicating that a file or a directory is shown in a predetermined list.

14. The control method according to any one of 8. to 13., in which in the determination step, an event graph representing an event sequence that includes the node representing the subject or the object of the event that is specified by an input operation, is acquired.

15. A program that causes a computer to execute each step of the control method according to any one of 8. to 14.

What is claimed is:

1. An information processing apparatus comprising:
a determination unit that acquires an event graph to be output and determines a subgraph satisfying a predetermined reference from the acquired event graph to be output; and
an output unit that outputs the event graph, with an output mode of the determined subgraph as a first mode and an output mode of another portion as a mode other than the first mode, wherein
the event graph represents an activity content in an event related to an activity of a program as an edge and represents each of a subject and an object of the event as a node, and
the first mode is a mode in which at least one of the number of nodes and the number of edges is reduced than the number of nodes and the number of edges included in the determined subgraph.

2. The information processing apparatus according to claim 1, wherein
the predetermined reference is a reference satisfied by a subgraph representing an event sequence that occurs in a normal state.

3. The information processing apparatus according to claim 2, wherein
the predetermined reference is a reference indicating that one process accesses a plurality of files having the same extension.

4. The information processing apparatus according to claim 2, wherein
the predetermined reference is a reference indicating communication with one process performed by a plurality of apparatuses belonging to the same subnet.

5. The information processing apparatus according to claim 2, wherein
the predetermined reference is a reference indicating that one process accesses a plurality of files or directories satisfying a second predetermined reference.

6. The information processing apparatus according to claim 5, wherein
the second predetermined reference is a reference indicating existing under a predetermined directory, or a reference indicating being shown in a predetermined list.

7. The information processing apparatus according to claim 1, wherein
the determination unit acquires an event graph representing an event sequence that includes the node representing the subject or the object of the event that is specified by an input operation.

8. A control method executed by a computer, the method comprising:
acquiring an event graph to be output and determining a subgraph satisfying a predetermined reference from the acquired event graph to be output; and
outputting the event graph, with an output mode of the determined subgraph as a first mode and an output mode of another portion as a mode other than the first mode, wherein
the event graph represents an activity content in an event related to an activity of a program as an edge and represents each of a subject and an object of the event as a node, and
the first mode is a mode in which at least one of the number of nodes and the number of edges is reduced than the number of nodes and the number of edges included in the determined subgraph.

9. The control method according to claim 8, wherein
the predetermined reference is a reference satisfied by a subgraph representing an event sequence that occurs in a normal state.

10. The control method according to claim 9, wherein
the predetermined reference is a reference indicating that one process accesses a plurality of files having the same extension.

11. The control method according to claim 9, wherein
the predetermined reference is a reference indicating communication with one process performed by a plurality of apparatuses belonging to the same subnet.

12. The control method according to claim 9, wherein
the predetermined reference is a reference indicating that one process accesses a plurality of files or directories satisfying a second predetermined reference.

13. The control method according to claim 12, wherein
the second predetermined reference is a reference indicating existing under a predetermined directory, or a reference indicating being shown in a predetermined list.

14. The control method according to claim 8, wherein
in the determining, an event graph representing an event sequence that includes the node representing the subject or the object of the event that is specified by an input operation, is acquired.

15. A non-transitory computer-readable storage medium storing a program that causes a computer to execute the control method according to claim 8.
